(19) United States
(12) Patent Application Publication
(10) Pub. No.: US 2014/0032260 A1
(43) Pub. Date: Jan. 30, 2014

(54) INFERING BEHAVIOR-BASED LIFESTYLE CATEGORIZATIONS BASED ON MOBILE PHONE USAGE DATA

(71) Applicant: GMH INTERNATIONAL, (US)

(72) Inventor: Peter GRINDROD, Oxon (GB)

(73) Assignee: GMH INTERNATIONAL

(21) Appl. No.: 13/841,852

(22) Filed: Mar. 15, 2013

Related U.S. Application Data
(63) Continuation-in-part of application No. 13/215,047, filed on Aug. 22, 2011.
(60) Provisional application No. 61/493,141, filed on Jun. 3, 2011.

(51) Int. Cl. G06Q 30/02

(52) U.S. Cl. CPC G06Q 30/0201
USPC 705/7.29

(57) ABSTRACT

A processor implemented method for categorizing mobile phone users. The method including receiving call level data for a plurality of mobile phone users, the call level data being for a period of common duration. After receiving the call level data, a raw attribute table can be updated by extracting raw attributes from the call level data. After updating the raw attribute table, a transformed attribute table based on the one or more raw attributes can also be updated. After updating the transformed attribute table, a selected model can be applied to the data of the updated transformed attribute table using parameters associated with the selected model. After applying the model, one or more output tables based on the applied selected model can be outputted.

### CROSS REFERENCE TO RELATED APPLICATIONS

This application is a continuation-in-part of U.S. patent application Ser. No. 13/215,047, filed on Aug. 22, 2011, and entitled “Inferring Credit Worthiness from Mobile Phone Usage,” which claims the benefit of U.S. Patent Application No. 61,493,141, filed on Jun. 3, 2011, entitled “Inferring Credit Worthiness from Mobile Phone Usage,” both of which are incorporated herein by reference in their entirety.

### FIELD OF INVENTION

The present technology relates to inferring behavior-based lifestyle categorizations of individuals based solely on mobile phone usage data. Such categorizations can be useful in a variety of targeting, marketing and risk-assessment applications.

### BACKGROUND

Mobile phone network operators (MNOs) routinely collect and store transaction data describing their users' individual transactions on one or more networks. Such data can be referred to as call-level data or call data records (CDRs). CDRs can describe each and every incoming and outgoing transaction on the mobile network. For example CDRs can include, but are not limited to, call date, call time, call type (e.g., voice, text message, mobile data), call duration, whether incoming or outgoing, call distance (e.g., local, regional, national, and international), the counterparty number, and call location (location of cell tower). CDRs can be used for MNO billing purposes, with a customer's billing charges often calculated as the cost associated with each CDR.

### BRIEF DESCRIPTION OF THE DRAWINGS

Implementations of the present technology will now be described, by way of example only, with reference to the attached figures, wherein:

FIG. 1 is a flow chart of a new model establishment process in accordance with an exemplary embodiment;

FIG. 2 is exemplary screenshot of raw CDR data for a mobile phone user in accordance with an exemplary embodiment;

FIG. 3 is a flow chart of a model operational process in accordance with an exemplary embodiment;

FIG. 4 is a list of the transformed attributes in accordance with an exemplary embodiment;

FIG. 5 is a screenshot of a transition matrix for the selected model in accordance with an exemplary embodiment; and

FIG. 6 is a block diagram of a processor-based computer in accordance with an exemplary embodiment.

### DETAILED DESCRIPTION

For simplicity and clarity of illustration, where appropriate, reference numerals have been repeated among the different figures to indicate corresponding or analogous elements. In addition, numerous specific details are set forth in order to provide a thorough understanding of the implementations described herein. However, those of ordinary skill in the art will understand that the implementations described herein can be practiced without these specific details. In other instances, methods, procedures and components have not been described in detail so as not to obscure the related relevant feature being described. Also, the description is not to be considered as limiting the scope of the implementations described herein.

In one or more embodiments, the methodology can include (i) extracting attributes that summarize behavior from one or more CDRs that represent users' transactions over specified time periods, and transforming these; (ii) applying a standard unsupervised discovery algorithm to find common behavioral patterns, called states, via a model partition of attribute space, (iii) selecting a suitable model partition so as to make a state to state transition matrix sparse and to avoid including very large or very small states and (iv) applying this partition model to characterize additional mobile phone users and over additional time periods. For each mobile phone user this results in a longitudinal sequence of states, each one representing the user's behavior within each successive time period. As a result, the methodology characterizes the user's behavior, and changes in such behavior, over time.

Customers on a mobile network purchase a smart card (known as a subscriber identification module or SIM card) that can be installed into their mobile device and that can contain subscriber-related data. The subscriber-related data can include, but is not limited to, the purchaser's name, address (including an area or zip code), the user's national identity or registration number, the user's sex, age, registration date, tariff type, and type of mobile device. Such data remains relatively static, changing only occasionally, whilst the CDRs are accumulated call by call, from moment to moment.

MNOs commonly use such static registration data for their own customer relationship management and marketing purposes. For example, they can use the customer's geographic location (captured by zip code or similar) to provide a classification of socio-economic status and market to them accordingly. However in the case of prepaid mobile devices, there can be limited or no static data about the SIM owner. Consequently many customer characterizations using registration data are not applicable to prepaid users. Even when registration data exists, such data can be unreliable since the user of the phone can be someone other than the registered SIM owner.

In one or more embodiments, MNOs can also collect episodic payment and account recharge or “top-up” data, including information about the user's payment for specific services. Such payments may be on a post-pay or pre-pay basis, depending on the customer's contractual relationship with the MNO. The data can include the dates and amounts of pre-payments/recharges for pre-pay customers, or the dates and amounts of post-pay settlement of bills. MNOs might employ such data to classify their customers according to payment/recharge history.

The methodology is directed to using the behavior data, held within the CDRs, to infer behavior-based classifications for mobile device users. Such a methodology is distinct from methods that use the static registration data or episodic payment and recharge data to classify customers, either separately or together. The methodology herein can rely upon the data obtained from CDRs. Such data reflects the lifestyle of the user, not the claimed identity data of the SIM owner, if known, nor the user's payment or recharge behavior.

“Lifestyle” can be considered a key variable in determining customers' likely responses to communications and promotional offers and customers' likely performance if and when they purchase particular products and services. CDRs can represent a valid, hard record of mobile phone usage that can be a proxy for the users' lifestyles, activities and circumstances. Moreover the lifestyle categorizations that result from such mobile phone usage behavior can be updated after each time period, providing an evolving, and thus responsive, description of subtle or step changes in the users' lifestyles. Hence, the methodology can be based entirely on the concept that CDRs can be employed to infer behavior-based insights into the mobile devices user's lifestyle for each time period and over multiple time periods.

In one or more embodiments, the methodology does not use information such as specific message or voice content that would violate the privacy of the MNO users. Rather, the methodology can exploit the existence and distribution (both in time and by type) of transactions over each time period to distinguish distinct classifications of user behavior, and by inference, of classifications of user lifestyles. In one or more embodiments, the methodology does not use information regarding calls made from specific cell locations. Rather, the methodology can exploit the pattern of calls present in CDRs over each time period. As a result, the privacy of individual message content and location can be maintained.

The method can output a categorization of each user's lifestyle, based on the CDR data, for a given time period (typically chosen to be a whole number of days or weeks, such that all time periods are similar and comparable). The categorization can be recalculated at the end of each time period. Hence a history can be developed of each user's behavioral classification over successive time periods. The behavior-based categorizations are thus dynamic over time. They evolve in a way that corresponds to the evolving changes in the user's behavior. The dynamic behavior-based categorizations (states) can be represented by “scores” or some other enumeration or nomenclature, derived from the CDR data.

Once established, these dynamic behavioral classifications can be useful in a variety of marketing, targeting and risk-assessment applications. In some applications the behavioral classifications can be used as covariates, along with historical performance data for a subset of customers, to infer responsiveness of other groups of customers to offers of products or services or to estimate the default or insurance risk in underwriting for each applicant. For example, in order to determine a customer's likely response to an offer of a specific product or service, an analyst could first identify a suitable subset of mobile phone users that have responded to such or similar offers in the past. The analyst could then infer a direct relationship between each mobile user's behavior-based classification at the time of the offer and the mobile user's likely future response, extrapolating from an historical subset to locate and qualify new, desirable targets or leads within the mobile customer base. Similarly, the analyst can determine the mobile customer's likely creditworthiness or the probability that the customer will continue to pay subscriptions beyond some pre-defined break-even point. In such case the analyst could first identify a subset of mobile phone users that have used the product or service (or a similar product or service) in the past, examine their payment histories, then infer a relationship between each mobile user's behavior-based classification at the time of the offer or application and the mobile user's likely future payment performance.

Once the relationship between behavior and response, risk or other attribute can be established, targeted offers of appropriate products or services can be assigned to customers in specified states. Such assignment can be accomplished (a) automatically by the computer matching offers with states based on some predefined criteria and/or (b) by the analyst following a review of attributes and states.

The methodology can include processes for:
Creation of Transformed Attribute Tables: summarizing the totality of user behavior using a plurality or all CDRs from each user over one or more time periods. This process can be a precursor to both Model Establishment and Model Application.
Model Establishment: the creation of a behavior-based categorization based solely upon the transformed attributes, based on the CDRs from a set of user time periods, to be employed within applications.
Model Application: the application and reapplication of the established behavior-based categorization to further incoming CDR data for further user time periods, so that every mobile user builds up a longitudinal record over time, characterizing their own behavior on the mobile device network within successive time periods.

The behavior-based categorization data (one class for each specific user time period) may be separated and exported independently from the input CDR data. Thus, the process protects the fine details of the mobile phone user's records, maintaining user privacy by not sharing any specific details of the mobile phone user's CDRs, while producing a lifestyle indicator that can be of direct interest to MNOs and their business partners as they seek to offer new products and services to MNO customers.

### Implementation

Reference now will be made in detail to implementations of the technology. Each example is provided by way of explanation of the technology only, not as a limitation of the technology. It will be apparent to those skilled in the art that various modifications and variations can be made in the present technology without departing from the scope or spirit of the technology. For instance, features described as part of one implementation can be used on another implementation to yield a still further implementation. Thus, it is intended that the present technology covers such modifications and variations that come within the scope of the technology.

The telecommunication network can be one or more conventional cellular network servicing mobile devices. A mobile device can be a device having a post-payment plan or a pre-payment plan. A mobile device can include, but is not limited to, portable communication devices, mobile communication devices, mobile computers, smart phones, computing pads, tablet computers, laptop computers, notebooks, or other electronic devices that are capable of transmitting data, receiving data, executing commands, and include their own power sources. Individual mobile device users can be identified by a unique identifier. For example, the unique identifier can be the phone number associated with the mobile device, the system subscriber identity (SSID) associated with the mobile device, or a registered identifier such as the national identity number associated with the mobile device user. Each unique user generates CDRs, whose data fields can include, but are not limited to, type of call (e.g., voice, SMS, data and so forth), incoming, outgoing, local, regional, national, international, start time of call, parties to the call, duration of the call, cell tower location of parties to the call. The CDR data can be obtained from one or more telecommunication networks. In one or more embodiments, customer account payment data can be included, although this is not required for the present method.

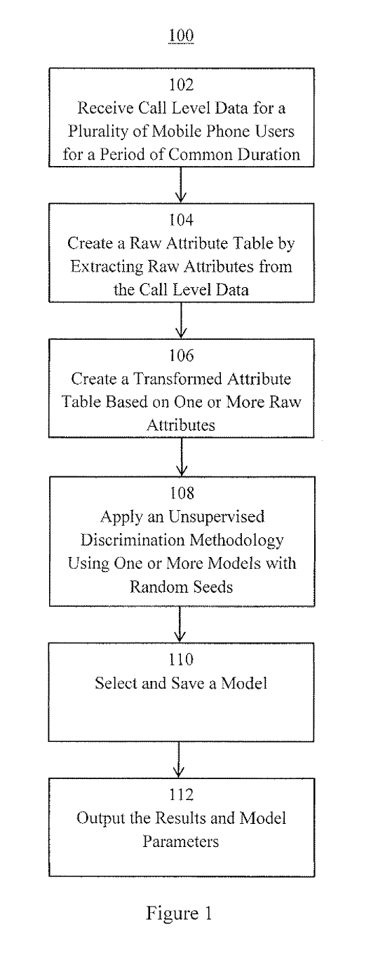

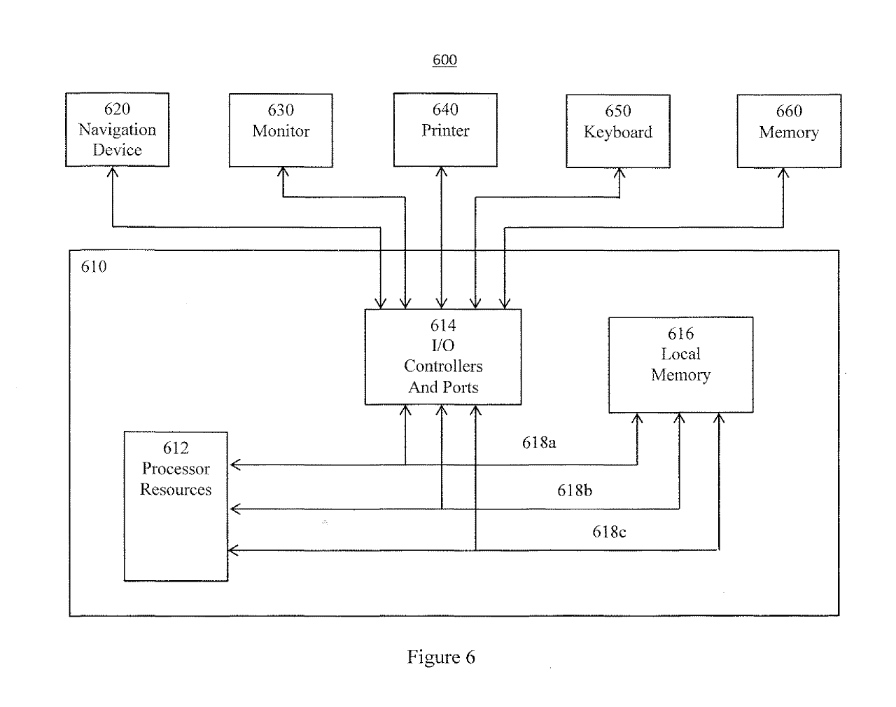

Referring to FIG. 1, a flowchart of a new model establishment method in accordance with an exemplary embodiment is illustrated. The new model establishment method can be used to generate and select from different models. Once a model is established, a model operation method can be used with the established model. The exemplary new model establishment method 100 is provided by way of example, as there are a variety of ways to carry out the method. The method 100 described below can be carried out using one or more processor based components, such as a server, a computer as shown in FIG. 6, and a computer readable medium, by way of example, and various elements of these figures are referenced in explaining exemplary method 100. Each block shown in FIG. 1 represents one or more processes, methods or subroutines, carried out in the exemplary method 100. The exemplary method 100 can begin at block 102.

At block 102, call level data (CDRs) for a plurality of mobile phone users for a period of common duration can be received. For example, a processor can receive the CDRs for a plurality of mobile phone users for a period of common duration. The plurality of mobile phone users can be a subset of all the mobile phone users or can be all of the mobile phone users. The common duration can be referred to as a user time period. In order to ensure that behavior can be comparable, the user time period can be defined as a whole number of weeks, so that each and every time period contains the same number of weeks. Typically, the time period can be two, four, six or eight whole weeks. In one or more embodiments, the user time period can be on a monthly basis, but such a user time period would vary due to the months having different number of days. As a result, the results would need to be adjusted to compensate for the different number of days. For example, weighting can be applied to the results in order to normalize the results and allow for the data in each time period to be compared.

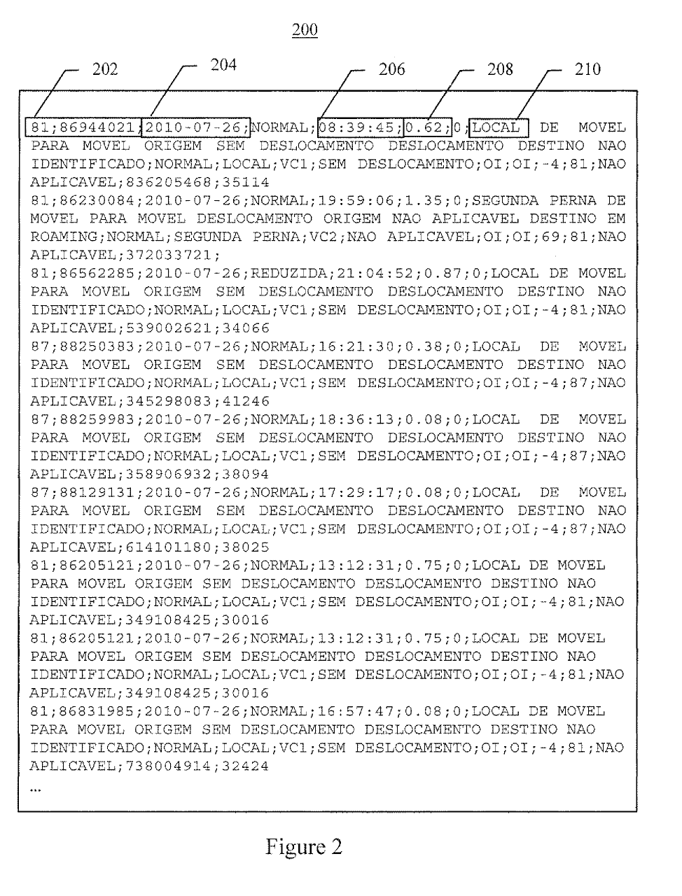

Referring to FIG. 2, CDR data for a mobile device user in accordance with an exemplary embodiment is illustrated. The CDR data can be filtered (normalized) in a number of ways, but can contain information for each call or transaction. The CDR data can be separated into outgoing calls, incoming calls, or a combination of outgoing calls and incoming calls. As shown, the CDR data can be for outgoing calls for a mobile device associated with a telephone number 202 and each entry includes the date of the call 204, time of day 206, duration of a phone call 208, and the type of call 210 (e.g., local, toll, or international). For example, the associated telephone number is (818)694-4021, the call occurred on Jul. 26, 2010 at 8:39:45 (eight thirty nine AM), the call lasted for sixty-two seconds, and was a local call.

Referring to FIG. 1 again, after receiving the CDRs, the method 100 can proceed to block 104. At block 104, a raw attribute table can be created by extracting raw attributes from the call level data. For example, the processor can create the raw attribute table. The encoded process extracts summary “raw attributes” derived from the CDRs, for each user time period. These raw attributes can describe the user's activity and its distribution by week-part, day-part, class, call type, and duration, as well as the volatility of the user's day-to-day usage over the specific time period. The summarized raw attribute data for a single user time period can be represented by an n-tuple of numbers. These numbers are typically held as a single line in a Raw Attributes Table containing a multiplicity of delimitated fields. The Raw Attributes Table is typically contained in a digital file stored on one or more computer-readable mediums, databases, or servers.

Exemplary raw attributes can include, but are not limited to: the number (count) of voice calls the phone user made/received in the time period, by distance classification; the number (count) of SMS messages the phone user sends/receives in the time period; the duration (e.g., cumulative, or average) of all calls involving the phone user in the period; time-of-day distribution of outgoing/incoming voice calls and SMS; number of distinct counterparties on all types of calls; number of cells from which types of call were made; week-part distribution of outgoing/incoming voice calls and SMS. In addition some of the attributes can describe the volatility of usage throughout the time period, for example a measure of the day-to-day variation in certain types of calls made throughout the time period. After creating the raw attribute table, the method 100 can proceed to block 106.

At block 106, a transformed attribute table can be created. For example, the processor can create the transformed attribute table. The transformed attribute table can have one line for each customer-time period, each containing a number of transformed attributes. Each transformed attribute can be based on one or more raw attributes for the corresponding user time period. The transformation of one, some or all of the raw attributes reflects the user behavior in a more useful way than the raw attributes. For example, attributes for a user time period that are simple counts can be binned on a geometrical scale, e.g., counts of the number of outgoing voice calls can be binned such that 1 call can be mapped to the unit-less value 1, 2 can be mapped to the unit-less value 2, 3-4 calls are mapped to the unit-less value 3, 5-8 calls are mapped to unit-less value 4, and so forth. The transform mapping between the raw attributes and the transformed attributes can be multinomial, for example, skews in call usage by day-part or week-part can be represented by multinomial variables each with a number of categorical values, and hence parameters. The transformed attribute types may include binary, integer, continuous (real), and categorical. The complete set of transformed and untransformed attributes can be large, e.g., 100 or more. The transformed attribute data together with the raw attribute data for a single user time period can be represented by an n-tuple of numbers, usually held as a single line within a file or a table containing a multiplicity of delimited fields and stored on one or more computer readable mediums, databases and/or servers. That table can be called a Transformed Attributes Table. After creating a Transformed Attribute Table, the method 100 can proceed to block 108.

At block 108, an unsupervised discrimination methodology with random seeds can be applied to the data from the Transformed Attributes Table. For example, the processor can apply the unsupervised discrimination methodology to the data. The unsupervised methodology can include establishing an “attribute space” using the transformed attribute data from the Transformed Attributes Table. The attribute space can be the set of all possible positions of a particular user time period, each represented by a vector of transformed attributes. Any particular user time period can be represented as a single corresponding point within the attribute space. The attribute space can be described by a mixture of real, binary integers and categorical variables. For example, using unsupervised discrimination, the attribute space can be partitioned into a complete collection of disjoint subsets. Such a partition can map each and every possible vector of transformed attributes onto a unique and well-defined categorization corresponding to the particular subset in which it lies. The subsets within a partition can be referred to as “behavioral states.” In the process of defining such a partition an unsupervised discrimination will identify states corresponding to naturally occurring clusters, or repeated patterns, within the attribute space. All user time periods within the same state are similar in a very real sense: their usage, as summarized by their transformed attributes, can lie clustered closely together within the transformed attribute space. Such a behavioral categorization model partition can be fully described by a set of model parameters that can be used to generate the corresponding attributes, by a computer encoded attribution process, and hence these parameters implicitly represent the desired partition. The full set of parameters can be stored on one or more computer-readable mediums, databases or servers as a model parameters file.

In any model partition there can be a unique state called the null state, which contains those user-time periods that correspond to zero CDR activity within the time period. Such user-time periods represent null behavior, with no usage of the mobile phone, perhaps because the user has left the network, and has lapsed temporarily or permanently, or perhaps because the user simply has not had the need to use his/her mobile phone during the time period. All of the other states correspond to transformed attributes where there can be at least some CDR activity; these are called active states.

Determination of state-wise partition via unsupervised discrimination can be made by application of unsupervised discrimination methods such as the Expectation Maximization (EM) or similar standard techniques that iterate towards a desirable partition. The modeling step can include random numbers, referred to as random seeds that control the starting point for an iterative scheme to determine data-driven partition. This step can be carried out computationally. It is effectively a generalized clustering algorithm, where the states emerge like clusters within attribute space. Hence the modeling step can be repeated independently by one or more processors for a possibly large number of trials. This produces a corresponding pool of alternative models, each seeded by a distinct set of random numbers. After applying the unsupervised methodology, the method 100 can proceed to block 110.

The method seeks to select an optimal model that (a) fully partitions the transformed attribute space (e.g., puts each user time-period into a unique state), (b) does not contain any excessively large or excessively small state populations of user time-periods, and (c) results in a sparse state transition matrix for phone users across periods.

In one or more embodiments, a desirable fraction of total mobile phone users within a single behavioral state can be no greater than some predetermined threshold. For example, starting with a partition model having eighty behavioral states, then on average there will be 1.25% of all user-time periods within each behavioral state. If any states have more than six times this amount (i.e., more than 7.5% of all user states), then the model will have low resolution for those users. In such a case, a different model partition that subdivides those user states further may be preferred. Similarly, if the model partition has a behavioral state containing less than 0.025% of all user time periods, equivalent to one fiftieth of the average state population, then the model may also be undesirable since such a state can hardly ever be encountered. (In the latter case such a model might still be useful if such a state represents rare or extreme behavior that is nonetheless of specific interest).

A further output of any model partition can be a state-to-state transition matrix, which can be a matrix with both an ordered row and column corresponding to each state. The matrix can contain all period-to-period transition rates, including lapsing rates (transitions form active states into the null state): these transition rates are the probability that any user in one state (corresponding to the row of the matrix) in a particular time period will move to another state (corresponding to the column of the matrix) in the next time period.

It is desirable that this transition matrix should be sparse in order that the sequential behavioral changes are relatively well defined for user-time periods within each state. Otherwise transitions would be commonly observed, indicating that the model has little power to predict and discriminate between future behavior based on knowledge of current behavior. A sparse transition matrix can be achieved by applying user-set tolerances to key performance measures. One such key performance measure can be a measure of non-sparseness of the transition matrix. This measure is defined by a count of all those transition matrix entries greater than 1%, normalized by the total number of entries (for a model with N states, the transition matrix contains N*N entries). This non-sparseness measure should be below a given user-set threshold, chosen so as to ensure that the users' current states are reasonable predictors of their next states, and their subsequent future states in successive time periods. Typically the non-sparseness of a model with N states should be less than 6/N, meaning that on average each individual user will either remain in their current state in the next time period or else will transit into one of (6−1)=5 specified other states in the next time period.

Together with the constraint that the maximum expected population fraction within any single state should be below a given user-set threshold, this allows the selection of a model partition that maximizes sparseness and minimizes the largest-state expected population.

Referring again to FIG. 1, at block 110, a model can be selected and saved. For example, the processor can select the model which maximizes a measure of the evenness of the state population fractions (to avoid any extremely large states) and also a measure of the sparsity of the resulting transition matrix. The selected model and associated parameters can be saved by the processor on one or more computer-readable mediums, databases or servers as a model parameters file. After selecting and saving a model, the method 100 can proceed to block 112.

The states are indexed or named either by an anonymous nomenclature or enumeration or by a “score.” The score may be some numerical value derived from the inferred or expected performance of those users at some later possible time with respect to some offering, product or service, independent of their mobile phone usage. Thus, the behavior states can be referred to by indicators of inferred performance for those user time periods or an enumeration (state 1, state 2 . . . ), or other fixed nomenclature that does not itself describe any specifics of the corresponding subsets of user time-period's raw or transformed attributes.

At block 112, one or more output tables can be outputted. For example, the processor can output one or more output tables. The output can be displayed on a display and/or be hard copies of the one or more output tables. The one or more output tables can include scores for each mobile device user, scores for a behavior state, or any other table in which the mobile device users are grouped.

The segmentation derived in the model establishment process can be data driven and describes both the distribution of individuals' behavior and the expected evolution of individuals' behavior (by making the transition matrix sparse). Applications of this type of model to marketing, targeting and risk assessment can have 50 to 100 states. This can be a high-resolution state-based dynamic segmentation.

The model can be stored by holding all of the parameters that together describe all of the states. Typically there will be many parameters for each state, since each state can be a region, or set of values, within transformed attribute space. These values can be stored in one or more computer-readable mediums, databases or servers. They can be used to partition any new sets of n-tuple of user time-periods. The complete set of parameters can be stored in a model parameters file, to be reused in the model application/operations as required.

After a model has been selected, the selected model and associated parameters can be applied to the CDR data for one or more user time periods. For example, given a stored model parameters file the operational methodology can apply the corresponding behavioral model categorization to new datasets of CDR data for the same or for other users and covering other user time-periods. CDR data for such user time-periods can be first transformed, in the same way as described above, and then the model can be applied to map unambiguously each and every separate user time-period to the relevant modeled partition or state. A primary output of this methodology can be an output table with fields, for example, User ID, User Time-Period, State, which can be queried within any standard database. The output tables can be updated as data from each new time period becomes available.

The output table can be exported in whole or part without revealing any of the specific details of the individual user's telephone usage. In this way the privacy of the mobile device user can be protected, while the user behavior within each period can be characterized by state assignment or score.

The assignments within the output table for both single mobile device users and groups of mobile device users can be used as described above to identify mobile device users for specification, for example in lead generation, termination, offers to encourage use that can be more profitable or to discourage less profitable use, reduce churn and so forth.

The segmentation introduced can be dynamic, reassigning states at the end of every user time-period. The dynamic segmentation results in a user-specific ordered sequence of successive states representing the behavior of that user over the corresponding successive user time-periods. By contrast, static segmentations typically used within customer relationship management systems are updated (reassigned to segments) ad-hoc or after arbitrary time-intervals such as six or twelve months.

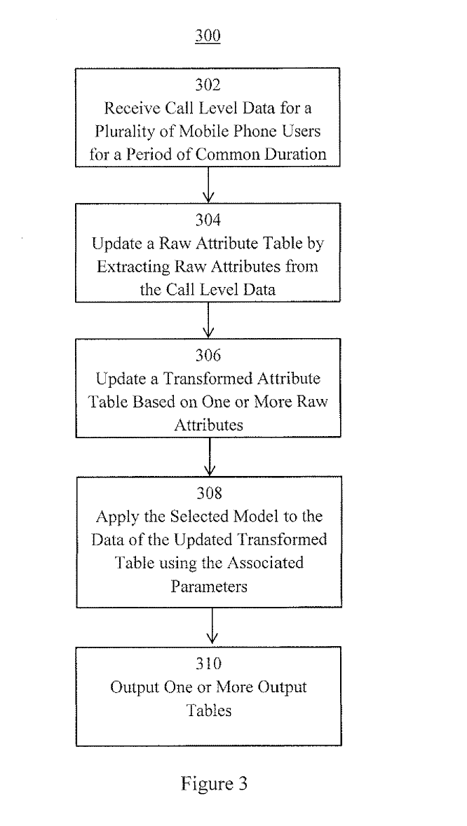

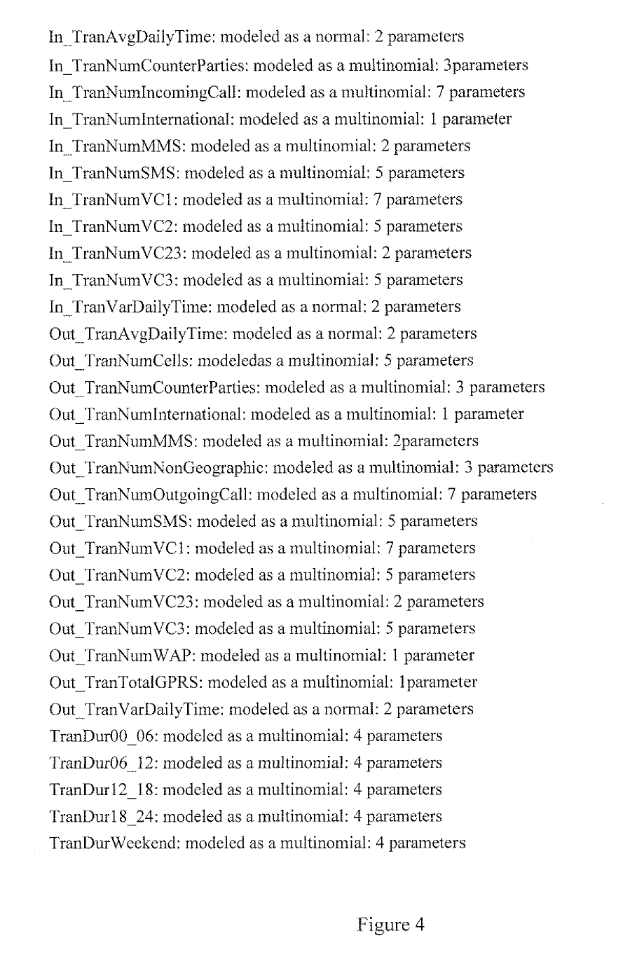

Referring to FIG. 3, a flowchart of a model operational method in accordance with an exemplary embodiment is illustrated. Once a model is established/selected, the model operational method can be used with that established model. The exemplary model operational method 300 is provided by way of example, as there are a variety of ways to carry out the method. The method 300 described below can be carried out using one or more processor based components, such as a server, a computer as shown in FIG. 4, and a computer readable medium, by way of example, and various elements of these figures are referenced in explaining exemplary method 300. Each block shown in FIG. 3 represents one or more processes, methods or subroutines, carried out in an exemplary method 300. The exemplary method 300 can begin at block 302.

At block 302, call level data (CDRs) for a plurality of mobile phone users for a new user time period of common duration can be received. For example, a processor can receive the CDRs for a plurality of mobile phone users. The plurality of mobile phone users can be typically all of the mobile phone users in a mobile network, but can be for a subset of the mobile phone users. The duration of the user time period of common duration would be over the same user time period that was previously used with the selected model when it was established (for example, a two week user time period). After receiving the CDRs, the method 300 can proceed to block 304.

At block 304, the raw attribute table can be updated with raw attributes extracted from the call level data. For example, the processor can extract the raw attribute table and update the raw attribute table that was created in the new model establishment method 100. The processor can extract summary “raw attributes,” derived from the CDRs, for the latest user time period. The updated table can typically be contained in a digital file stored on one or more computer-readable medium, databases, or servers. After updating the raw attribute table, the method 300 can proceed to block 306.

At block 306, the Transformed Attributes Table based on one or more raw attributes can be updated. For example, the processor can update the Transformed Attributes Table. This process can be exactly the same as that carried out in defining the transformed attributes used during the new model establishment method 100. For the selected model, after updating the Transformed Attribute Table, the method 300 can proceed to block 308.

At block 308, the selected model can be applied to the data of the updated Transformed Attributes Table using the associated parameters. For example, the processor can apply the selected model to the updated transformed attribute table.

At block 310, one or more output tables can be outputted. For example, the processor can cause one or more output tables to be displayed or printed. The one or more output tables can include scores for each mobile device user, scores for a behavior state, or any other table in which the mobile device users are grouped.

The one or more output tables can be similar to the output tables outputted from method 100, but can be for the latest user time period. In one or more embodiments, one or more transition tables can be outputted. The transition tables can show proportions of all mobile users that have exhibited state-to-state transitions between any and all pairs of consecutive user time periods. The tables are constructed by calculating the fraction of customers in any given state that transition to any other state in the subsequent time period.

The output behavior-based categorization data can be used for several purposes, including, but not limited to, marketing, risk assessment, and so on. The methodology relates solely to the derivation of dynamic behavior-based categorizations (states), which are represented by “scores” or other enumeration or nomenclature, derived or chosen from the CDR data, and the ongoing operational assignment of such outputs to incoming data for subsequent user time periods.

The segmentation introduced can be dynamic, reassigning states at the end of every user time-period. The dynamic segmentation results in a user-specific ordered sequence of successive states representing the behavior of that user over the corresponding successive user time-periods. By contrast, static segmentations typically used within customer relationship management systems are updated (reassigned to segments) ad-hoc or after arbitrary time-intervals such as six or twelve months.

### Illustrative Example of Model Establishment

A set of Call Data Records from 2.7 million prepay customers' traffic (all calls, all SMS, all data, in and out, local, regional, national, international, time, duration, etc.) over 20 consecutive weeks, was used to illustrate the partition of all such customers' behavior into a large number of distinct and mutually exclusive behavioral patterns, or clusters, called “states.” Once established over a sampled subset of users, this dynamic behavioral segmentation remained fixed and was applied to all customers for all fortnights for which full traffic data was available.

To establish this illustrative model, a randomly sampled subset of 20,000 customers' transactions over the 20-week period was used. First, a user time-period was selected: two-week time periods (fortnights) were chosen, so that the users' behavior would be evaluated and classified after every consecutive fortnight. Accordingly for this example project each customer's data can be divided into consecutive fortnights. The sample of 20,000 customers over 10 fortnights yielded 160,110 complete, active, customer-fortnights (the remainder being null where the customer had no traffic whatsoever).

For each fortnight the process summarizes each customer's individual behavior by extracting thirty-one raw attributes (twenty seven categorical variables and four real-valued metrics). These represented different types of usage (voice, SMS, and data), incoming and outgoing traffic, local, regional, national and international traffic, skews towards both day parts and week parts, geographical information and the distribution of total incoming and outgoing usage durations.

The raw attributes (fractions, counts and sums) were transformed so as to highlight certain sensitive differences, to suppress irrelevancies, and to adopt certain types of distributions in anticipation of the automated model establishment process discussed below. The transformed attributes are listed in FIG. 4. The exemplary transformed attributes can have fifty (50) state models, forty-nine (49) mixing parameters with the total number of parameters including group-mixing proportion: 5,649.

These transformed attributes were in turn described by a total of M=112 degrees of freedom (summary parameters). This defined the transformed attribute space. Thus each user time-period (fortnight) was summarized by its location in an M-dimensional transformed attribute space.

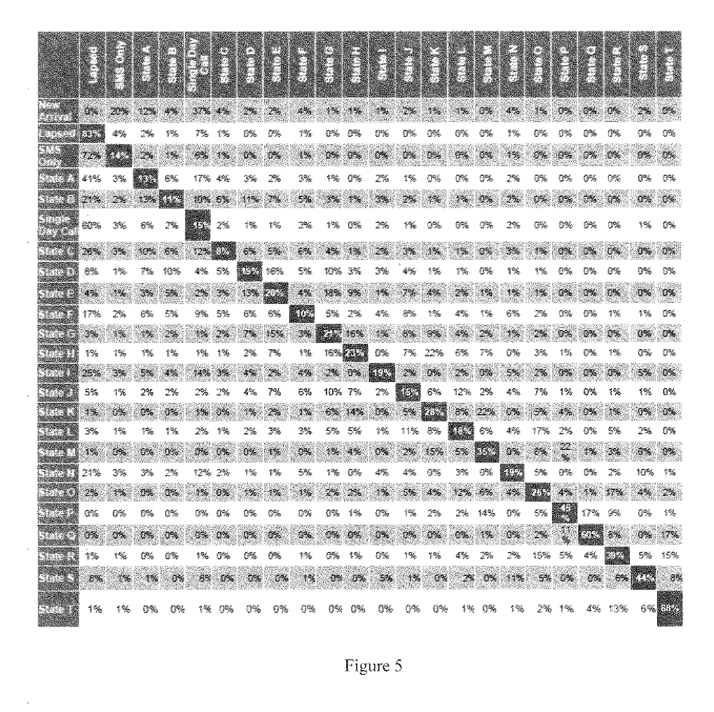

Next an N=50 state model was fully specified by N−1 mixing parameters (the expected fraction of customer fortnights within each state) and the distribution parameters. The process applied to this data employed a version of the EM algorithm, producing a description of the whole distribution in terms of a 50-way state partition. This was carried out a large number of times and a final model was selected so as to avoid both large and small state-populations, and to maximize the sparsity of the corresponding transition matrix. The exemplary transition matrix for the final model is shown in FIG. 5. The range of customer-fortnight behavior can be described by a set of 50 behavioral patterns. Each can represents a typical “fingerprint” of a behavior, characterizing the customer-fortnights within that particular state (partition within transformed attribute space).

The present technology can take the form of hardware, software or both hardware and software elements. In some implementations, the technology can be implemented in software, which includes but is not limited to firmware, resident software, microcode, a Field Programmable Gate Array (FPGA), graphics processing unit (GPU), or Application-Specific Integrated Circuit (ASIC). In particular, for real-time or near real-time use, an FPGA or GPU implementation would be desirable.

Furthermore, portions of the present technology can take the form of a computer program product comprising program modules accessible from computer-usable or computer-readable medium storing program code for use by or in connection with one or more computers, processors, or instruction execution system. For the purposes of this description, a computer-usable or computer readable medium can be any apparatus that can contain, store, communicate, propagate, or transport the program for use by or in connection with the instruction execution system, apparatus, or device. The medium can be non-transitory (e.g., an electronic, magnetic, optical, electromagnetic, infrared, or semiconductor system (or apparatus or device)) or transitory (e.g., a propagation medium). Examples of a non-transitory computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. Both processors and program code for implementing each as aspect of the technology can be centralized or distributed (or a combination thereof) as known to those skilled in the art.

Referring to FIG. 6, a data processing system 600 in accordance with an exemplary embodiment is illustrated. The data processing system 600 can be one or more computers, one or more servers, or can be instructions stored on a tangible or non-transitory readable storage media. The data processing system 600 can be suitable for storing a computer program product of the present technology and for executing the program code of the computer program product can include at least one processor (e.g., processor resources 612) coupled directly or indirectly to memory elements through a system bus (e.g., 618 comprising data bus 618a, address bus 618b, and control bus 618c). The memory elements can include local memory (e.g., 616) employed during actual execution of the program code, bulk storage (e.g., 660), and cache memories (e.g., including cache memory as part of local memory or integrated into processor resources) that provide temporary storage of at least some program code in order to reduce the number of times code must be retrieved from bulk storage during execution. Input/output or I/O devices (including but not limited to keyboards 650, displays 630, pointing devices 620, etc.) can be coupled to the system either directly or through intervening I/O controllers (e.g., 614). Network adapters can also be coupled to the system to enable the data processing system to become coupled to other data processing systems or remote printers or storage devices through intervening private or public networks. Modems, cable modem and Ethernet cards are just a few of the currently available types of network adapters. Such systems can be centralized or distributed, e.g., in peer-to-peer and client/server configurations. In some implementations, the data processing system can be implemented using one or both of FPGAs and ASICs.

The various embodiments described above are provided by way of illustration only and should not be construed to limit the scope of the disclosure. Examples within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection can be properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply not only to a smartphone device but to other devices capable of receiving communications such as a laptop computer. Those skilled in the art will readily recognize various modifications and changes that may be made to the principles described herein without following the example embodiments and applications illustrated and described herein, and without departing from the scope of the disclosure.

What is claimed is:

1. A processor implemented method for categorizing mobile phone users, the method comprising:
receiving, by a processor, call level data for a plurality of mobile phone users, the call level data being for a period of common duration;
updating, by the processor, a raw attribute table by extracting raw attributes from the call level data;
updating, by the processor, a transformed attribute table based on the one or more raw attributes;
applying, by the processor, a selected model to data of the updated transformed attribute table using parameters associated with the selected model; and
outputting one or more output tables based on the applied selected model.

2. The processor implemented method of claim 1 wherein the plurality of mobile phone users comprise at least one of prepaid mobile phone users, post-pay mobile phone users, and any combination thereof.

3. The processor implemented method of claim 1 wherein the period of common duration is one of one week, two weeks, three weeks and four weeks.

4. The processor implemented method of claim 1 wherein the applying the selected model further comprises:
receiving, by the processor, call level data for a plurality of mobile phone users, the call level data being for a period of common duration;
creating, by the processor, a raw attribute table by extracting raw attributes from the call level data for each mobile phone user and over the period of common duration;
creating, by the processor, a transformed attribute table based on one or more of the raw attributes including assigning one or more categorical values to one or more of the raw attributes;
applying, by the processor, an unsupervised discrimination methodology using one or more models with random seeds to the transformed attribute table; and
selecting and saving, by the processor, a model and associated model parameters.

5. The processor implemented method of claim 1 wherein the one or more outputted tables comprise a score for each mobile user.

6. The processor implemented method of claim 1 wherein the one or more outputted tables comprise a score for a behavioral state and a list of mobile users associated with the behavioral state.

7. The processor implemented method of claim 1 wherein the one or more outputted tables comprise a transition table listing mobile users who have transitioned from one behavioral state to another behavioral state over one or more period of common duration.

8. A non-transitory computer readable medium comprising computer readable instructions that are executable by at least one processor to perform a method comprising:
receiving, by a processor, call level data for a plurality of mobile phone users, the call level data being for a period of common duration;
updating, by the processor, a raw attribute table by extracting raw attributes from the call level data;
updating, by the processor, a transformed attribute table based on the one or more raw attributes;
applying, by the processor, a selected model to data of the updated transformed attribute table using parameters associated with the selected model; and
outputting one or more output tables based on the applied selected model.

9. The non-transitory computer readable medium of claim 8 wherein the plurality of mobile phone users comprise at least one of prepaid mobile phone users, post-pay mobile phone users, and any combination thereof.

10. The non-transitory computer readable medium of claim 8 wherein the period of common duration is one of one week, two weeks, three weeks and four weeks.

11. The non-transitory computer readable medium of claim 8 wherein the applying the selected model further comprises:
receiving, by the processor, call level data for a plurality of mobile phone users, the call level data being for a period of common duration;
creating, by the processor, a raw attribute table by extracting raw attributes from the call level data for each mobile phone user and over the period of common duration;
creating, by the processor, a transformed attribute table based on one or more of the raw attributes including assigning one or more categorical values to one or more of the raw attributes;
applying, by the processor, an unsupervised discrimination methodology using one or more models with random seeds to the transformed attribute table; and
selecting and saving, by the processor, a model and associated model parameters.

12. The non-transitory computer readable medium of claim 8 wherein the one or more outputted tables comprise a score for each mobile user.

13. The non-transitory computer readable medium of claim 8 wherein the one or more outputted tables comprise a score for a behavioral state and a list of mobile users associated with the behavioral state.

14. The non-transitory computer readable medium of claim 8 wherein the one or more outputted tables comprise a transition table listing mobile users who have transitioned from one behavioral state to another behavioral state over one or more period of common duration.
